(19) United States
(12) Patent Application Publication
(10) Pub. No.: US 2019/0034162 A1
(43) Pub. Date: Jan. 31, 2019

(54) VIRTUAL REALITY DEVICE AND INPUT CONTROL METHOD THEREOF

(71) Applicant: GoerTek Technology Co., Ltd., Qingdao City, Shandong (CN)

(72) Inventor: Yanli ZHAO, Qingdao City, Shandong (CN)

(21) Appl. No.: 16/081,278

(22) PCT Filed: Dec. 31, 2016
(86) PCT No.: PCT/CN2016/114048

§ 371 Date: Aug. 30, 2018

(30) Foreign Application Priority Data
Nov. 24, 2016 (CN) 201611045610.9

(51) Int. Cl. G06F 3/16; G06F 3/023; G10L 15/22; G10L 15/18

(52) U.S. Cl. CPC G06F 3/167; G06F 3/0233; G06F 3/04883; G10L 15/1815; G10L 15/22

(57) ABSTRACT

A virtual reality device and an input control method for a virtual reality device are disclosed. The virtual reality device comprises: a microprocessor, a display screen, a microphone and a memory that are connected with the microprocessor. The microprocessor identifies semantics of voice information collected by the microphone and converts them to text information; and detects whether a cursor is on the display screen, and if yes, inputs the text information to a position of the cursor on the display screen, and if no, compares the text information to keywords in the memory, and when an operation command is detected and is for executing a visual interface operation, executes the corresponding visual interface operation; and when an operation command is detected and is for opening an application or a file, detects whether the application or file name exists in remaining text information, and if yes, opens a corresponding application or file.

### TECHNICAL FIELD

The present disclosure relates to the technical field of virtual reality, and particularly relates to a virtual reality device and an input control method for a virtual reality device.

### BACKGROUND

Virtual reality technology will become a new breakthrough that changes our life style, but there is still a long way to go for virtual reality technology to really enter the consumer market. There are still many technical difficulties to overcome by developers to provide users a real immersive experience of games or applications, and for many of them we have no way out so far.

The various currently available virtual reality devices cannot satisfy the requirement of communication between the user and the virtual world. The greatest challenge that virtual reality faces may be how to interact with the target in the virtual world. How to realize input control of virtual reality is a big problem that troubles the developers and hardware manufacturers of head-mounted devices. The existing touch screens and 3D input methods are not friendly enough for the user to input contents.

### SUMMARY

In view of the above problems, the present disclosure provides a virtual reality device and an input control method for a virtual reality device, to solve the problem of the existing virtual reality devices that they are not friendly enough for the user to input contents.

To achieve the above objects, the technical solutions of the present disclosure are as follows:

In an aspect, the present disclosure provides a virtual reality device, comprising: a microprocessor, and a display screen, a microphone and a memory that are connected with the microprocessor, wherein

the microphone is for collecting voice information;

the memory is for storing keywords, the keywords comprise: operation commands, application names and file names, the operation commands comprise: a command for executing a visual interface operation and a corresponding command for opening an application or a file; and

the microprocessor is for identifying semantics of the voice information collected by the microphone and converting them to text information; and detecting whether a cursor is on the display screen, and if yes, inputting the converted text information to a position of the cursor on the display screen, and if no, comparing the text information with the keywords in the memory, detecting whether an operation command is in the text information, and when an operation command is detected and it is the command for executing a visual interface operation, executing the corresponding visual interface operation; and when an operation command is detected and it is the corresponding command for opening an application or a file, detecting whether the application name or the file name exists in remaining text information, and when it is detected that the application name or the file name exists, opening a corresponding application or file, and if no, giving by using the display screen prompting information that there is no executable command.

Optionally, the microprocessor is further for counting up in real time times for which the keywords in the memory are detected, and rearranging the keywords in the order from high to low detected times; and when a new application is being installed or an existing application is being deleted, or a new file is being written or an existing file is being deleted, updating the application names or file names in the memory.

In another aspect, the present disclosure further provides an input control method for a virtual reality device, the virtual reality device comprises a display screen and a microphone, wherein the method comprises:

prestoring keywords, wherein the keywords comprise: operation commands, application names and file names, and the operation commands comprise: a command for executing a visual interface operation and a corresponding command for opening an application or a file;

collecting voice information by using the microphone;

identifying semantics of the voice information collected by the microphone and converting them to text information; and

detecting whether a cursor is in the display screen, and if yes, inputting the converted text information to a position of the cursor on the display screen, and if no, comparing the text information with the prestored keywords,

detecting whether an operation command is in the text information, and when an operation command is detected and it is the command for executing a visual interface operation, executing the corresponding visual interface operation; and when an operation command is detected and it is the corresponding command for opening an application or a file, detecting whether the application name or the file name exists in remaining text information, and when it is detected that the application name or the file name exists, opening a corresponding application or file, and if no, giving by using the display screen prompting information that there is no executable command.

Optionally, the method further comprises: counting up in real time times for which the keywords are detected, rearranging the keywords in the order from high to low detected times, and when comparing the text information with the prestored keywords next time, comparing the keywords according to the order from high to low;

when a new application is being installed or an existing application is being deleted, or a new file is being written or an existing file is being deleted, updating the keywords.

The advantageous effects of the present disclosure are as follows. The present disclosure provides a virtual reality device and an input control method for a virtual reality device. The virtual reality device, by means of voice control, realizes text input, and executing visual interface operation to the device or opening an application or a file, and can automatically identify the voice information of the user, intelligently judge whether the user is trying to input text, or executing visual interface operation, or opening an application or a file, and further execute the corresponding operation. Thereby, the present disclosure improves the convenience of operating virtual reality device by the user, optimizes man-machine interaction, and further enhances the virtual reality experience.

Further, the virtual reality device of the embodiment of the present disclosure can also count up in real time the times for which the keywords in the memory are detected, rearrange the keywords in the order from high to low detected times, and when comparing the text information with the keywords prestored in the memory next time, compare the keywords in the order from high to low, thereby improving the comparison efficiency.

### BRIEF DESCRIPTION OF DRAWINGS

FIG. 1 is a schematic diagram of a virtual reality device according to an embodiment of the present disclosure;

FIG. 2 is a logic flow chart of the operation of a virtual reality device according to an embodiment of the present disclosure; and

FIG. 3 is a flow chart of an input control method for a virtual reality device according to an embodiment of the present disclosure.

### DETAILED DESCRIPTION

The design concept of the present disclosure is that, the virtual reality device collects voice information by using a microphone, identifies semantics of the voice information and converts them to text information, when it is detected that a cursor is on the display screen, inputs the text information to a position of the cursor, and when it is detected that there is no cursor on the display screen, detects whether the text information is an operation command, and if it is an operation command, further judges whether the operation command is a command for executing a visual interface operation or a corresponding command for opening an application or a file, and converts it to a system instruction to execute the corresponding operation. Thereby, the present disclosure improves the convenience of operating the virtual reality device by the user, optimizes man-machine interaction, and further enhances the virtual reality experience.

In order to make the objects, the technical solutions and the advantages of the present disclosure clearer, the embodiments of the present disclosure will be further described below in detail in conjunction with the drawings.

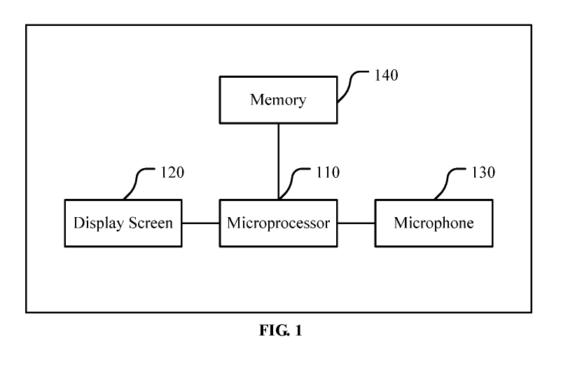

An embodiment of the present disclosure provides a virtual reality device. As shown in FIG. 1, the virtual reality device comprises: a microprocessor 110, and a display screen 120, a microphone 130 and a memory 140 that are connected with the microprocessor 110.

The microphone 130 is for collecting voice information.

The memory 140 is for storing keywords. The keywords comprise: operation commands, application names and file names. The operation commands comprise: a command for executing a visual interface operation and a corresponding command for opening an application or a file.

The microprocessor 110 is for identifying semantics of the voice information collected by the microphone 130 and converting them to text information. Particularly, the microprocessor 110 encodes and then converts the voice information to a digital signal, then performs voice recognition by using voice recognition algorithm (ASR), extracts the semantics of the user, and converts them to text information. This belongs to the prior art and is not discussed further.

The microprocessor 110 is further for detecting whether a cursor is on the display screen 120, and if yes, inputting the converted text information to a position of the cursor on the display screen 120; and if no, comparing the text information with the keywords in the memory 140, detecting whether an operation command is in the text information, and when an operation command is detected and it is the command for executing a visual interface operation, converting the operation command to the corresponding system instruction, and executing the corresponding visual interface operation; and when an operation command is detected and it is the corresponding command for opening an application or a file, detecting whether the application name or the file name exists in remaining text information, and when it is detected that the application name or the file name exists, opening a corresponding application or file, and if no, giving by using the display screen 120 prompting information that there is no executable command.

As can be seen from the above, the virtual reality device of the embodiment of the present disclosure, by means of voice control, realizes text input, and executing visual interface operation to the device or opening an application or a file, and can automatically identify the voice information of the user, intelligently judge whether the user is trying to input text, or executing visual interface operation, or opening an application or a file, and further execute the corresponding operation, thereby improving the convenience of user operation, optimizing man-machine interaction, and further enhancing the virtual reality experience.

In the embodiment of the present disclosure, when the virtual reality device needs to connect a wireless network and the password is inputted, the password obtained by the voice recognition may be directly written to the position of the cursor by a background service, which can solve the problem of the existing virtual reality devices that characters cannot be easily inputted by using a keyboard.

In the embodiment of the present disclosure, the virtual reality device further comprises a touch screen or a keyboard (not shown in the figures).

When the text information inputted to the position of the cursor has an error, the cursor is moved by using the touch screen or the keyboard to amend the text information or re-input text.

In the embodiment of the present disclosure, the microprocessor 110, when the command for executing a visual interface operation is determined, executes the corresponding visual interface operation by using a background service process; and when the command for opening an application or a file is determined, opens the corresponding application or file by using a system broadcasting.

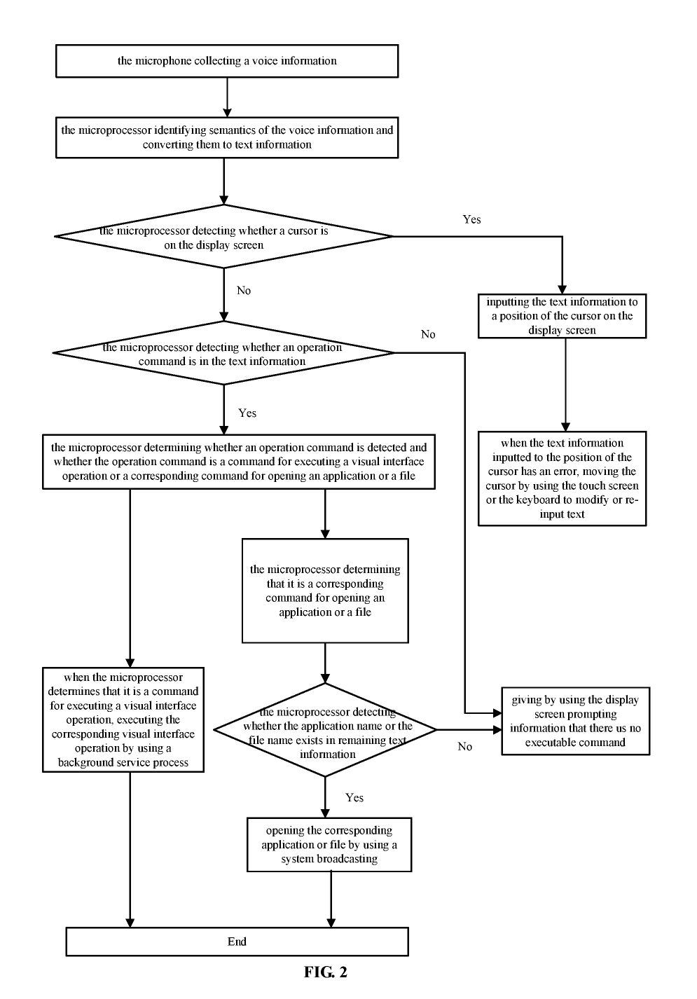

As shown in FIG. 2, the logic flow of the operation of the virtual reality device of the embodiment of the present disclosure is as follows:

the microphone collecting voice information, and the microprocessor identifying semantics of the voice information and converting them to text information, and detecting whether a cursor is on the display screen;

if yes, inputting the text information to a position of the cursor on the display screen, and if no, detecting whether an operation command is in the text information;

if no operation command exists, giving by using the display screen prompting information that there is no executable command; if an operation command exists, determining that an operation command is detected and judging whether the operation command is a command for executing a visual interface operation or a corresponding command for opening an application or a file, if it is determined to be a command for executing a visual interface operation, executes the corresponding visual interface operation by using a background service process, if it is determined to be a corresponding command for opening an application or a file, detecting whether the application name or the file name exists in remaining text information, if an application name or a file name exists, opening the corresponding application or file by using a system broadcasting, and if no application name or file name exists, giving by using the display screen prompting information that there is no executable command.

In the embodiment of the present disclosure, the command for executing a visual interface operation comprises: page turning, video pausing, continuing playing a video and so on. For example, if the operation command is “page turning”, the microprocessor switches the system interface from the current interface to the next interface. The corresponding command for opening an application or a file may, for example, be “starting up”, “opening” and so on.

In the embodiment of the present disclosure, the microphone 130 comprises a main microphone and one or more auxiliary microphones. The microprocessor 110 is further for, according to voice information collected by the one or more auxiliary microphones, filtering out noise in the voice information, to improve the accuracy of the voice recognition. Particularly, the microprocessor 110 stores a voice noise reduction algorithm. This belongs to the prior art and is not discussed further.

In the embodiment of the present disclosure, the microprocessor 110 is further for, when a new application is being installed or an existing application is being deleted, or a new file is being written or an existing file is being deleted, updating the application names or file names in the memory 140. The microprocessor 110 is further for counting up in real time the times for which the keywords in the memory 140 are detected, and rearranging the keywords in the order from high to low detected times, that is, arranging the keywords in the order from high to low usage frequency, and when comparing the text information with the prestored keywords next time, comparing the keywords in the order from high to low.

Along with the continuous accumulation of videos or games in the virtual reality device, the applications or files in the memory 140 will increase. If the keywords are rearranged in the order from high to low detected times, the microprocessor, when comparing the text information with the keywords in the memory 140 next time, preferentially compares the keywords of higher usage frequencies, to improve the keyword comparison efficiency and quickly find the keywords.

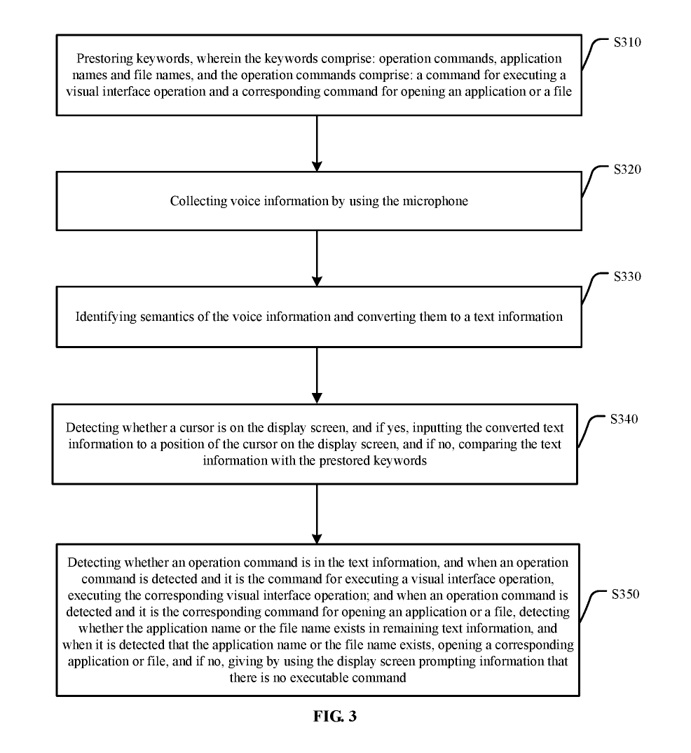

The embodiment of the present disclosure further provides an input control method for a virtual reality device, and the virtual reality device comprises a display screen and a microphone. As shown in FIG. 3, the method comprises:

Step S310: prestoring keywords, wherein the keywords comprise: operation commands, application names and file names, and the operation commands comprise: a command for executing a visual interface operation and a corresponding command for opening an application or a file;

Step S320: collecting voice information by using the microphone; Step S330: identifying semantics of the voice information collected by the microphone and converting them to text information;

Step S340: detecting whether a cursor is on the display screen, and if yes, inputting the converted text information to a position of the cursor on the display screen, and if no, comparing the text information with the prestored keywords; and

Step S350: detecting whether an operation command is in the text information, and when an operation command is detected and it is the command for executing a visual interface operation, executing the corresponding visual interface operation; and when an operation command is detected and it is the corresponding command for opening an application or a file, detecting whether the application name or the file name exists in remaining text information, and when it is detected that the application name or the file name exists, opening a corresponding application or file, and if no, giving by using the display screen prompting information that there is no executable command.

In the embodiment of the present disclosure, the microphone comprises a main microphone and one or more auxiliary microphones, the method further comprises: according to voice information collected by the one or more auxiliary microphones, filtering out noise in the voice information collected by the main microphone, to improve the accuracy of the voice recognition.

In the embodiment of the present disclosure, the method further comprises: when the text information inputted to the position of the cursor has an error, moving the cursor by using a touch screen or a keyboard of the virtual reality device to amend the text information or re-input text.

In the embodiment of the present disclosure, the step of executing the corresponding visual interface operation comprises: executing the corresponding visual interface operation by using a background service process; the opening a corresponding application or file comprises: opening the corresponding application or file by using a system broadcasting.

In the embodiment of the present disclosure, the method further comprises: when a new application is being installed or an existing application is being deleted, or a new file is being written or an existing file is being deleted, updating the keywords.

In the embodiment of the present disclosure, the method further comprises: counting up in real time times for which the keywords are detected, rearranging the keywords in the order from high to low detected times, and when comparing the text information with the prestored keywords next time, comparing the keywords according to the order from high to low, thereby improving the comparison efficiency.

In conclusion, the embodiment of the present disclosure provides a virtual reality device and an input control method for a virtual reality device. The virtual reality device, by means of voice control, realizes text input, and executing visual interface operation to the device or opening an application or a file, and can automatically identify the voice information of the user, intelligently judge whether the user is trying to input text, or executing visual interface operation, or opening an application or a file, and further execute the corresponding operation. Thereby, the present disclosure improves the convenience of operating virtual reality device by the user, optimizes man-machine interaction, and further enhances the virtual reality experience.

The above merely describes particular embodiments of the present disclosure. By the teaching of the present disclosure, a person skilled in the art can make other modifications or variations on the basis of the above embodiments. A person skilled in the art should appreciate that, the above special description is only for the purpose of better explaining the present disclosure, and the protection scope of the present disclosure should be subject to the protection scope of the claims.

What is claimed is:

1. A virtual reality device, comprising: a microprocessor, and a display screen, a microphone and a memory that are connected with the microprocessor, wherein
the microphone is for collecting voice information;
the memory is for storing keywords, the keywords comprise: operation commands, application names and file names, the operation commands comprise: a command for executing a visual interface operation and a corresponding command for opening an application or a file; and
the microprocessor is for identifying semantics of the voice information collected by the microphone and converting them to text information; and detecting whether a cursor is on the display screen, and if yes, inputting the converted text information to a position of the cursor on the display screen, and if no, comparing the text information with the keywords in the memory, detecting whether an operation command is in the text information, and when an operation command is detected and it is the command for executing a visual interface operation, executing the corresponding visual interface operation; and when an operation command is detected and it is the corresponding command for opening an application or a file, detecting whether the application name or the file name exists in remaining text information, and when it is detected that the application name or the file name exists, opening a corresponding application or file, and if no, giving by using the display screen prompting information that there is no executable command.

2. The virtual reality device according to claim 1, wherein
the microprocessor, when the command for executing a visual interface operation is determined, executes the corresponding visual interface operation by using a background service process; and when the command for opening an application or a file is determined, opens the corresponding application or file by using a system broadcasting.

3. The virtual reality device according to claim 1, wherein the microprocessor is further for counting up in real time times for which the keywords in the memory are detected, and rearranging the keywords in the order from high to low detected times; and when a new application is being installed or an existing application is being deleted, or a new file is being written or an existing file is being deleted, updating the application names or file names in the memory.

4. The virtual reality device according to claim 1, wherein the microphone comprises a main microphone and one or more auxiliary microphones, and the microprocessor is further for filtering out noise in the voice information according to voice information collected by the one or more auxiliary microphones.

5. The virtual reality device according to claim 1, wherein the virtual reality device further comprises a touch screen or a keyboard; and
when the text information inputted to the position of the cursor has an error, the cursor is moved by using the touch screen or the keyboard to amend the text information or re-input text.

6. An input control method for a virtual reality device, the virtual reality device comprising a display screen and a microphone, wherein the method comprises:
prestoring keywords, wherein the keywords comprise: operation commands, application names and file names, and the operation commands comprise: a command for executing a visual interface operation and a corresponding command for opening an application or a file;
collecting voice information by using the microphone;
identifying semantics of the voice information collected by the microphone and converting them to text information; and
detecting whether a cursor is on the display screen, and if yes, inputting the converted text information to a position of the cursor on the display screen, and if no, comparing the text information with the prestored keywords,
detecting whether an operation command is in the text information, and when an operation command is detected and it is the command for executing a visual interface operation, executing the corresponding visual interface operation; and when an operation command is detected and it is the corresponding command for opening an application or a file, detecting whether the application name or the file name exists in remaining text information, and when it is detected that the application name or the file name exists, opening a corresponding application or file, and if no, giving by using the display screen prompting information that there is no executable command.

7. The method according to claim 6, wherein
the step of executing the corresponding visual interface operation comprises: executing the corresponding visual interface operation by using a background service process; and
the step of opening a corresponding application or file comprises: opening the corresponding application or file by using a system broadcasting.

8. The method according to claim 6, further comprising:
counting up in real time times for which the keywords are detected, rearranging the keywords in the order from high to low detected times, and when comparing the text information with the prestored keywords next time, comparing the keywords in the order from high to low; when a new application is being installed or an existing application is being deleted, or a new file is being written or an existing file is being deleted, updating the keywords.

9. The method according to claim 6, wherein the microphone comprises a main microphone and one or more auxiliary microphones, and the method further comprises:
according to voice information collected by the one or more auxiliary microphones, filtering out noise in the voice information collected by the main microphone.

10. The method according to claim 6, further comprising:
when the text information inputted to the position of the cursor has an error, moving the cursor by using a touch screen or a keyboard of the virtual reality device to amend the text information or re-input text.
